(19) United States
(12) Patent Application Publication
(10) Pub. No.: US 2025/0209532 A1
(43) Pub. Date: Jun. 26, 2025

(54) Method to Determine Assets Which are Present on a Vehicle and Asset Determination System for a Vehicle

(71) Applicant: Hilti Aktiengesellschaft, Schaan (LI)

(72) Inventors: Muhammad Salman MALIK, Augsburg (DE); Alfred LUPPER, Aystetten (DE)

(21) Appl. No.: 18/390,831

(22) Filed: Dec. 20, 2023

(51) Int. Cl. G06Q 40/06; G07C 5/04

(52) U.S. Cl. CPC G06Q 40/06; G07C 5/04

(57) ABSTRACT

A method to determine assets which are present on a vehicle includes the steps: determining at a first time a first set of assets by an asset detector, the asset detector being on the vehicle; determining at a second time a second set of assets by the asset detector; monitoring a motion status indicator of the vehicle by a vehicle motion status monitor; and forming an intersection of at least the first set of assets and the second set of assets. Where for forming the intersection, the motion status indicator indicates a motion of the vehicle at the first time and the motion status indicator indicates a motion of the vehicle between the first time and the second time or a motion which is stopped for less than a predefined time period between the first time and the second time.

### BACKGROUND AND SUMMARY OF THE INVENTION

The present invention relates to a method to determine assets, particularly power tools and accessories to power tools, which are present on a vehicle, to an asset determination system for a vehicle, to a vehicle with the asset determination system, and to a computer program product to carry out the method.

There are various situations where it is advantageous to identify assets which are transported in a vehicle, e.g., for tracking assets in a delivery van or for tracking assets, such as power tools and their accessories, in a site vehicle or a vehicle of a construction crew or a craftsman. Tracking the assets on a vehicle can be used as part of an asset management system, where locations, which might be also mobile locations, such as vehicles, are tracked. Tracking assets on a vehicle might avoid forgetting tools or material when traveling to or from a construction site.

Van inventory management is generally known. For example, in “Van Gateway—ON!Track Van Inventory Management”, https://www.youtube.com/watch?v=TX_ZSDqpb2A, retrieved Nov. 6, 2023, Hilti Great Britain describes advantages and problems associated with van inventory management.

One problem of automated van inventory management is to discriminate between assets in a vehicle and assets outside the vehicle, however, in close proximity to the vehicle. This problem may arise, for example, when assets are identified via radiofrequency signals, e.g., Bluetooth signals or with radio frequency identification. For example, on a construction site or in a warehouse there might be a plurality of assets inside and outside of a vehicle, all able to be detected and without further information it is unclear whether the assets are in the vehicle or outside of the vehicle.

It is one object of the present invention to provide an improved method to determine assets present on a vehicle, a system for determining assets on a vehicle and a vehicle equipped with the system enabling to discriminate between assets inside and outside the vehicle for determining of the assets present on a vehicle.

A method to determine assets which are present on a vehicle is provided. The method comprises the steps of: determining at a first time a first set of assets by an asset detector, the asset detector being on the vehicle; determining at a second time a second set of assets by the asset detector; monitoring a motion status indicator of the vehicle by a vehicle motion status monitor; and forming an intersection of at least the first set of assets and the second set of assets, wherein the motion status indicator indicates a motion of the vehicle at the first time and the motion status indicator indicates a motion of the vehicle between the first time and the second time or a motion, which is stopped for less than a predefined time period between the first time and the second time.

When a vehicle is moving, usually no assets are added anymore to the vehicle or taken from the vehicle. However, when determining assets, in particular, by means of contactless technology, e.g., making use of radio waves, both assets in the vehicle and outside the vehicle may be identified. By determining sets of assets at different times, while the vehicle is moving, and building an intersection of the determined sets of assets, the probability that an asset, which is included in the intersection, is positive on the vehicle, is increased.

A vehicle could be, for example, a passenger car used by, for example, a technician, it could be a delivery or service van, it could be a construction truck, or it could be trailer. An asset is on the vehicle if it is transported together with the moving vehicle, whether it is in a passenger compartment, a trunk compartment, on a loading space or in a container of or on the vehicle.

A motion status indicator may have a direct relation to a motion of the vehicle, such as the GPS location data of the vehicle or the speed data of the vehicle, or a more indirect relation, such as vibrations or accelerations of the vehicle or that the ignition of the vehicle is on.

The times for the first and/or second may be externally triggered or taken from a periodic determination of a set of assets. For example, the first time might be triggered by accelerating the vehicle after not moving, by switching on the ignition, by pressing the accelerator. The second time might be triggered by stopping the vehicle or by a predetermined time, e.g., 1 minute, after the first time. Alternatively, a periodic scanning for assets might take place, e.g., once every minute, the results of the determination of the sets of assets for such periodic scans together with information on movement of the vehicle, the motion status indicator, may be stored in a memory. For forming the intersection at least a first time and a second time is chosen from the periodic scans, such that the motion status indicator indicates a movement of the vehicle from the first to the second time, and the associated first and second sets of assets are used for the intersection.

In an embodiment, the method comprises the steps of determining at one or more further times one or more further sets of assets by the asset detector and forming the intersection including the one or more further sets of assets, wherein the motion status indicator indicates a motion of the vehicle between the second time and the one or more further times or a motion, which is stopped for less than a predefined time period between the second time and the one or more further times.

In particular, for a periodic determining of sets of assets it can be useful to include in the intersection the further determined sets of assets, thus making full use of the information available from the determinations. For example, after a vehicle has started with assets in the vehicle and around the vehicle, a first determination might find both assets within the vehicle and outside of the vehicle. While the vehicle is moving, some assets outside might still be in a range to be found in a second determination. A third determination might provide assets which are passed by, however, not any longer may provide the assets outside of the vehicle from the first determination. Therefore, the intersection is stabilized around the assets on the vehicle.

In an embodiment, the intersection is formed by intersecting at least a first intersection and a second intersection or a first intersection and a third set of assets. When doing periodic determinations of sets of assets it is convenient to intersect the last determined set of assets, while the motion status indicator indicates a movement of the vehicle, with an intersection of the previous determinations of sets of assets. This enables to only store the last intersection, comprising the information from the previous determinations, which assets may be on the vehicle, and intersect this intersection with the newest determination of a set of assets, thus being an efficient way to handle the data. Continuing intersections may be made as long as the motion status indicator indicates a motion, including a motion stopped for less than a predetermined time.

In an embodiment, the motion status monitor is receiving the motion status indicator from a sensor on the vehicle, particularly, from a GPS sensor, from a motion or vibration sensor, and/or from an acceleration sensor. The sensors may be fixed to or part of the vehicle or may be separate from the vehicle.

In an embodiment, the motion status monitor is receiving the motion status indicator from the vehicle, particularly, receiving an ignition-on-indicator, vehicle speed or wheel speed sensor data, GPS data, rotational speed data, and/or battery voltage data. A vehicle can provide various indicators which can indicate a movement of the vehicle. A lot of vehicles are equipped with a navigation system and thus have access to GPS data. Vehicle speed and wheel speed are regularly measured to show the speed to the driver and/or as input for vehicle systems, such as an antilock braking system. However, indirect motion state indicators, such as the battery voltage, e.g., derived from a charging port such as the cigarette lighter voltage, may be used.

In an embodiment, the motion state indicator is received via an on-board-diagnostics (OBD) of the vehicle, via a controlled area network (CAN) bus, via a Deutsch connector, via a charging port, e.g., a cigarette lighter, and/or using a SAE J1939 protocol. The vehicle may be accessed for the method to determine the assets present on the vehicle in various ways. Several of the ways need access to connectors of the vehicle, in other situations even the cigarette lighter may be sufficient.

In an embodiment, determining the assets by the asset detector comprises scanning, particularly by a gateway, for signals of assets or tags, particularly for RF signals, particularly for Bluetooth signals and/or for signals from RFID transponders.

The assets to be identified may send RF beacons. Alternatively, tags, which send RF beacons may be attached to the assets. A device, such as a gateway, may scan for the RF beacons, e.g., in form of Bluetooth signals, and determine a set of assets in the proximity of the device by the information based on the found beacons. Active or passive RFID tags on the assets to be identified might also be used for determining sets of assets.

In an embodiment, the period between the first time and the second time is larger than a predefined minimum period, the vehicle speed between the first time and the second time is higher than a predetermined minimum speed, and/or the distance travelled by the vehicle exceeds a predetermined minimum distance. To increase the probability that no assets outside the vehicle are part of the intersection, there might be requirements for the first and/or second time. Usually after a motion for, for example, 1 minute or a traveling distance of more than 100 m, or a movement with a speed of more than 30 km/h, most assets outside the vehicle should be outside a detection range.

In an embodiment, information is sent to an asset management system, e.g., via a cellular phone network. For example, the determined first, second and/or one or more further sets of assets, the monitored motion status indicator, and/or the formed intersection may be sent to an asset management system, particularly to a server or a backend of the asset management system. Depending on the sent information, the asset management system may also perform steps of the method to determine the assets present on the vehicle. For example, when the determined sets of assets are forwarded to the asset management system, the asset management system may form the intersection of the sets of assets and thus determine the assets present on the vehicle.

An asset determination system for a vehicle is provided, which comprises an asset detector configured to determine at a first time a first set of assets and at a second time a second set of assets; a vehicle status monitor configured to monitor a motion status indicator of the vehicle; and one or more processors configured to choose the first time, such that the motion status indicator indicates a motion of the vehicle at the first time, choose the second time, such that the motion state indicator indicates a motion of the vehicle between the first time and the second time or a motion which is stopped for less than a predefined time period between the first time and the second time, and form an intersection of at least the first set of assets and the second set of assets.

An asset detector may be implemented by a gateway or by a mobile phone being able to scan for RF signals, such as RF beacons, e.g., Bluetooth beacons, or RFID signals. The RF signals may be sent by the assets or by tags attached to the assets. A scan may take between 10 seconds and 2 minutes, particularly between 30 seconds and 1 minute. The time period between the first time and the second time may be between 1 and 2 minutes. The scans might be periodically, and the processors choose the first and the second time appropriately in a way that the vehicle with the assets to be determined moves between the first time and the second time. Alternatively, the first and the second time may be chosen and a scan for assets may be initiated, for example, after starting the vehicle and after stopping the vehicle. A motion status indicator is monitored to be able to choose the first and the second time in a way that the vehicle is in motion between the first and the second time or only stopped for a predetermined time, e.g., a stop for less than 30 seconds might usually be not sufficient to change, in a regular situation, the assets on the vehicle. The vehicle status monitor can be implemented on the one or more processors configured to choose the first and second time or on further one or more processors. An intersection of the first and second set of assets can be made with one or more processors. The asset determination system may be implemented in one device such as a mobile phone, which may be carried on the vehicle, or a mobile gateway, which can be attached to the vehicle, or may be implemented in a distributed way, for example, with parts of the asset determination system being realized by devices or functions of the vehicle.

In an embodiment, the asset determination system is comprising a GPS sensor, a motion sensor, a vibration sensor, and/or an acceleration sensor, to provide the motion status indicator for the vehicle status monitor. Various sensors may be used to provide a motion status indicator. Particularly, sensors separate from the vehicle may be used, making the asset determination system independent from vehicle data and flexible for use in various vehicles. The asset determination system may also use sensor data available from the vehicle or a combination thereof.

In embodiments, the asset determination system is comprising a connector connectable to the vehicle for receiving the motion status indicator by the vehicle status monitor. Vehicles often have motion data available which can be used via a connection of parts of the asset determination system with the vehicle.

In embodiments, a mobile device, particularly a mobile phone or a smart phone, and/or a device built-in into the electronics of the vehicle is used as asset detector, as vehicle status monitor, and/or is used to choose the first and the second time and/or to form the intersection.

There are various ways to implement the asset determination system. For example, a mobile phone might be used as asset determination system. A mobile phone has acceleration sensors and can derive position data. The mobile phone can also be used to scan for Bluetooth signals sent by the assets, and on a mobile phone an app may be running storing and tracking the data and forming an intersection. An asset determination system may also use distributed systems and sub-systems. For example, the motion status indicator may be sent directly from the vehicle to an asset management system, hosted in a cloud environment or on a backend, via mobile communications; the sets of assets are determined by a specific scan device, e.g., for RFID-tags, and also communicated to the asset management system; the asset management system forms the intersection on a server.

A vehicle with the described asset determination system is provided, in particular, wherein the asset determination system is connected to the vehicle. The asset determination system may be implemented fixed to, integrated with or, for example, partly, attachable and detachable from the vehicle. There might be physical connections, e.g., electrical connections to the vehicle, in particular to an on-board-diagnostics (OBD) of the vehicle, to a controlled area network (CAN) bus, to a Deutsch connector, and/or to a charging port, particularly, the cigarette lighter of the vehicle.

Further a computer program product is provided comprising instructions which, when the program is executed on one or more first processors, the one or more first processors cause the computer to carry out the described method for determining the assets present on a vehicle with the described asset determination system and/or the described vehicle.

The various embodiments of the method for determining the assets present on a vehicle may be combined with the disclosed asset determination system, the described vehicle, and/or the disclosed computer program product.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings.

### BRIEF DESCRIPTION OF THE DRAWINGS

FIG. 1 shows a vehicle with an asset determination system;

FIG. 2 shows the vehicle with the asset determination system parking in a warehouse or jobsite environment;

FIG. 3 shows the vehicle with the asset determination system parking in the warehouse or jobsite environment with an asset moved;

FIG. 4 shows the vehicle with the asset determination system moving in the warehouse or jobsite environment;

FIG. 5 shows the vehicle with the asset determination system moving outside the warehouse or jobsite environment;

FIG. 6 shows the vehicle with the asset determination system moving outside the warehouse or jobsite environment in proximity to an asset outside the vehicle; and

FIG. 7 shows in a flowchart a process flow of a method to determine assets which are present on a vehicle.

### DETAILED DESCRIPTION OF THE DRAWINGS

In the Figures, like reference numerals designate like or functionally equivalent elements, unless otherwise indicated.

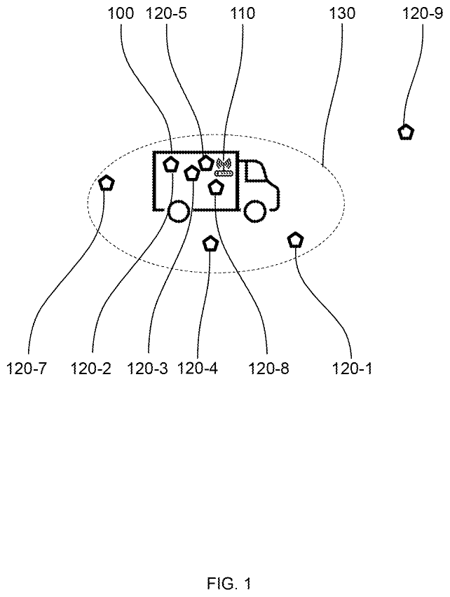

FIG. 1 shows the general situation of a vehicle 100 with an asset determination system. There is a gateway 110 on the vehicle. The gateway 110 scans for Bluetooth beacons from assets 120 or tags on assets 120. There are assets 120-2, -3, -5, and -8 which are within the vehicle 100. There are assets 120-1, -4, and -7 which are outside of the vehicle 100, however, the assets 120-1, -4, and -7 are within the scan range of the gateway 110, i.e., the signal strength of the assets 120-1, -4, and -7 is high enough to be detected by the gateway 110. The asset determination system can only determine that the assets 120-2, -3, -5, and -8 and the assets 120-1, -4, and -7 are in the scan range 130 of the gateway 110, however, the system cannot determine based on the scan information alone, which assets 120 are in the vehicle 100. Asset 120-9 is outside the scan range 130 and is not found by the gateway 110 in a scan.

To determine the assets 120 present on the vehicle 100 the gateway 110 is now periodically scanning the assets 120 in its proximity. The gateway 110 is scanning all beacons in its scan range 130 regardless of whether the beacon is sent from a tag or asset 120 on the vehicle 100 or from outside the vehicle 100. The asset determination system, which might be implemented in the gateway 110 can detect if the vehicle 100 is moving and it is assumed that no tags or assets 120 are removed or added to the inventory of a vehicle 100 while the vehicle 100 is moving.

There are various ways the gateway 110 can be connected to a vehicle 100 and detect if the vehicle 100 is moving or not. For example, the gateway 110 can be retrofitted to the vehicle 100 and can be connected, for example, to an on-board diagnostics (OBD) port, to a 12V charging port, or via any connectors like J1939 or Deutsch plug. The gateway 110 can be built-in into the electronics of a vehicle 100 or it can be a battery powered gateway 110, which is placed in the van for asset determination during work trips to jobsites.

To detect whether the vehicle 100 is moving or not, the gateway 110 can be equipped with an accelerometer or a GPS tracker to determine if the vehicle 100 is moving or stopped. If the gateway 110 is connected via OBD, J1939 or Deutsch connector the gateway 110 can read data from the controlled area network (CAN) bus to detect if the ignition is turned on or off or if the vehicle 100 has started to move or not, e.g., by reading the rotational speed data of the engine or the speed data of the vehicle 100. The gateway 110 may also be connected to the ignition wire in the vehicle to detect if the engine is turned on or off. The gateway 110 may also detect changes in the voltage level of vehicle's 100 battery to determine if the ignition is turned on or off. For example, if the gateway 110 is connected to the OBD port, the battery voltage on the OBD port is always active, however, the voltage level changes when the ignition is turned on or off. Similarly, the gateway 110 may detect the change in voltage level to determine if the engine is turned on or off from 12 V charging ports.

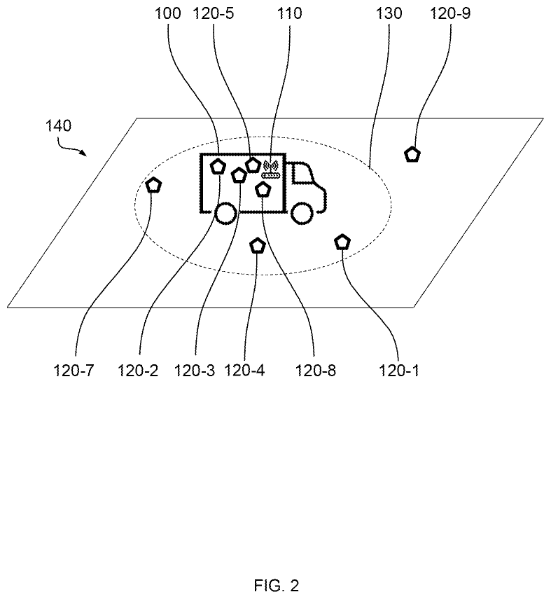

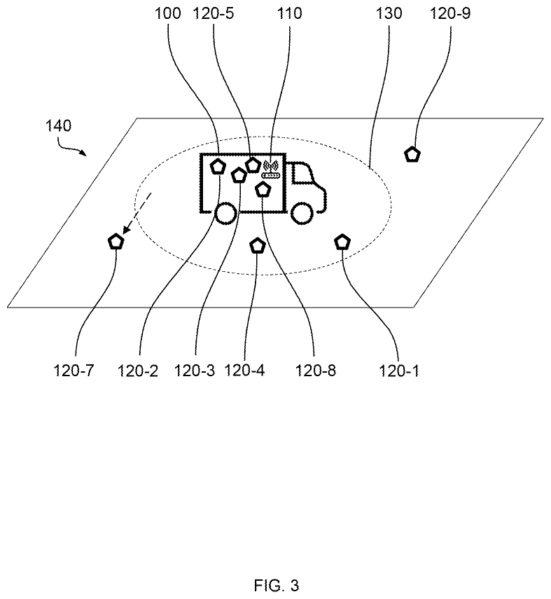

FIG. 2 shows the vehicle 100 with the asset determination system parking in a warehouse or jobsite environment 140. At a time T1 the gateway 110 scans for Bluetooth beacons and determines a T1-set of assets. The gateway 110 may scan with low cadence as the vehicle 100 is not found moving, e.g., as the ignition is turned off. The gateway 110 finds in this T1-set of assets the assets 120-2, -3, -5, and -8, which are in the vehicle 100, and the assets 120-1, -4, and -7, which are outside the vehicle 100, however, within the scan range 130. In FIG. 3 the asset 120-7 is moved. At a time T2, after the asset 120-7 has been moved, a determined T2-set of assets comprises the assets 120-2, -3, -5, and -8 and the assets 120-1, and -4.

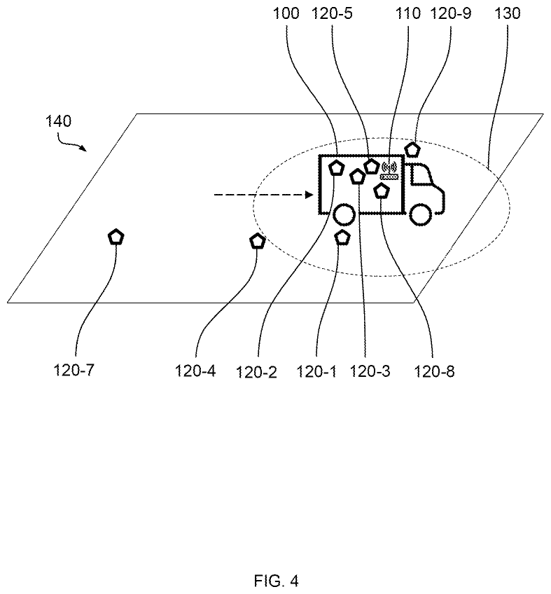

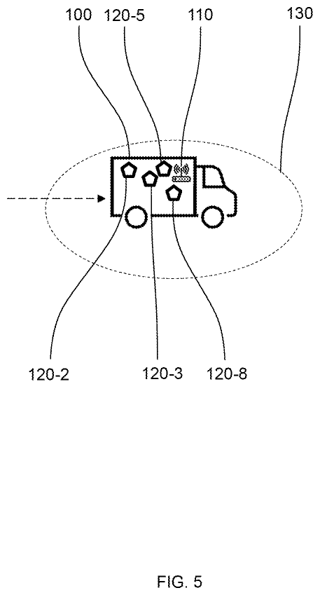

FIG. 4 shows the vehicle 100 with the asset determination system moving in the warehouse or jobsite environment 140. The vehicle 100 has just started moving and is still in the warehouse or jobsite environment 140. At a time T3, which may be a time in a row of periodic times or which may be triggered by a motion status monitor, which monitors a motion status indicator of the vehicle 100 and determines that the vehicle 100 started moving, a T3-set of assets is determined by the gateway 110 scanning for Bluetooth beacons. The gateway 110 finds the assets 120-2, -3, -5, and -8, which are in the vehicle 100, and the assets 120-1, and -9, which are outside the vehicle 100. FIG. 5 shows the situation, when the vehicle 100 is further moving and has left the warehouse or jobsite environment 140. At a time T4, which might be predetermined 2 minutes after start of the vehicle 100 moving or which might be a periodic scan time, a T4-set of assets is determined. The gateway 110 finds in the T4-scan only the assets 120-2, -3, -5, and -8, which are all in the vehicle 100. Assets 120 in the warehouse or jobsite environment 140 may not be found anymore after the movement of the vehicle 100. While moving, the asset determination system may reduce the frequency for a periodic determination of sets of assets, as no assets 120 may be added to the vehicle 100 or taken from the vehicle 100, the frequency may also be reduced only after a predetermined number of scans, e.g., after 4 scans.

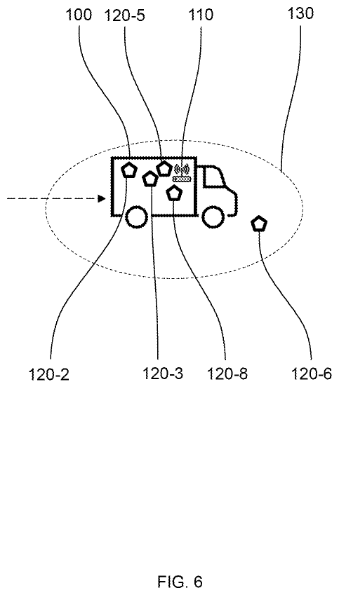

FIG. 6 shows the vehicle 100, with the asset determination system, moving outside the warehouse or jobsite environment 140 in proximity to an asset 120-6 outside the vehicle 100. While moving, the vehicle 100 may come close accidentally to assets 120 which are, for example, in no connection to the vehicle 100. However, when an asset 120 is in the proximity of the vehicle 100, in particular within the scan range 130, the asset 120 will be part of the set of assets, which may be determined at this time.

The below table depicts the situation and the determined sets of assets 120 at times T1 to T5.

| Time | Set of assets determined | | | | | | | | | Phase |
|---|---|---|---|---|---|---|---|---|---|---|
| T1 | 120-1 | 120-2 | | 120-4 | 120-5 | | 120-7 | 120-8 | | parked |
| T2 | 120-1 | 120-2 | 120-3 | 120-4 | 120-5 | | | 120-8 | | |
| T3 | 120-1 | 120-2 | 120-3 | | 120-5 | | | 120-8 | 120-9 | moving |
| T4 | | 120-2 | 120-3 | | 120-5 | | | 120-8 | | |
| T5 | | 120-2 | 120-3 | | 120-5 | 120-6 | | 120-8 | | |

For each time T1 to T5 the assets 120, which are part of the set of assets 120 at this time, are shown and the table shows whether the vehicle 100 is moving or not.

To determine which assets 120 are present on the vehicle 100, the assumption is made that no assets 120 can be added to the inventory of the vehicle 100 while the vehicle 100 is moving.

Assets 120 which are constantly seen on the vehicle 100 in several sets of assets, i.e., over several scan times, particular, while the vehicle 100 is moving, are therefore most probably in the vehicle.

The assets 120 present on the vehicle 100 can be determined by forming the intersection of the sets of assets 120 while the vehicle is moving, with A(Tx) being the determined set of assets 120 at the time Tx.

$$A ( T 3 ) ∩ A ( T 4 ) ∩ A ( T 5 ) = \{ 120 - 2 , 120 - 3 , 120 - 5 , 120 - 8 \}$$

The intersection of the determined sets of assets while the vehicle 100 was moving is 120-2, 120-3, 120-5, and 120-8. From this it can be deducted that those assets are located on the vehicle 100 and not outside or close by.

An asset management system allows the users to define locations. Locations can represent actual physical locations, e.g., warehouses, jobsites, containers, and vehicles 100. Users can also assign assets 120 to different locations defined in the asset management system, check the status of their inventory at these locations, track their assets 120 and receive notifications about updates related to their assets 120. For example, an asset manager can define a vehicle 100 as a location in the asset management system and assign assets 120 to this vehicle 100 depending upon the jobsites it needs to visit. The asset manager and a driver of the vehicle 100 want to track these assets 120 to know if they are present in the vehicle 100 or missing from there or where they were last seen if not present on the vehicle 100. The asset management system also supports interfaces via computer, smartphone or tablet applications for the asset managers or workers. The assets 120 present in the vehicle 100 can be determined using the described method.

Using information about the assets 120 assigned to the vehicle 100 in the asset management system and assets 120 determined to be present in the vehicle 100, the asset management system can determine if all expected assets 120 are present on the vehicle 100 or if any assets 120 are missing. Based on this evaluation, the asset management system can create a notification for users, e.g., to a warehouse manager or to the driver of the vehicle 100 on their computer or smartphone to notify if any asset 120 is missing from the vehicle 100. The asset management system can also regularly check the current inventory of assets 120 in the vehicle 100. Similarly, if an unexpected asset 120 is determined to be present on the vehicle 100, the users can be notified about this as well. If an automated transfer of assets 120 based on their current location is enabled in the asset management system, such assets 120 can be automatically reassigned from their previous location to their new location, i.e., the vehicle 100 where they are present.

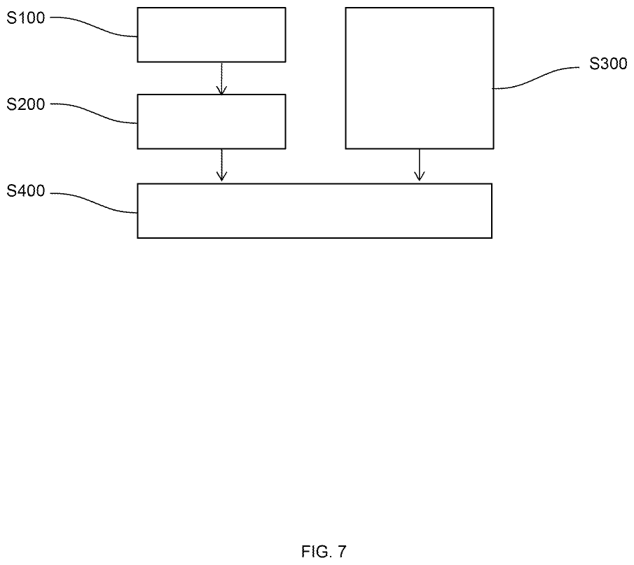

FIG. 7 shows in a flowchart a process flow of a method to determine assets 120 which are present on a vehicle 100. In step S100, a first set of assets 120 is determined at a first time by an asset detector, the asset detector being on the vehicle 100. This may be, for example, the set of assets 120 determined at time T3 in the above example. In step S200, at a second time, a second set of assets 120 is determined by the asset detector. This could be, for example, the set of assets 120 determined at time T4 in the above example. In step 300, in parallel to steps S100 and S200 or close in time to the steps S100 and S200, a motion status indicator of the vehicle 100 is monitored by a vehicle motion status monitor. In step S400, an intersection of at least the first set of assets 120, e.g., the set A(T3), and the second set of assets 120, e.g., the set A(T4), is formed. The first time and the second time are chosen in a way, wherein the motion status indicator indicates a motion of the vehicle 100 at the first time and the motion status indicator indicates a motion of the vehicle 100 between the first time and the second time or a motion, which is stopped for less than a predefined time period between the first time and the second time. Of course, forming the intersection might include further sets of assets determined at further times, e.g., the set of assets 120 A(T5) which is determined at the time T5.

Although the present invention has been described in accordance with preferred embodiments, it is obvious for the person skilled in the art that modifications are possible in all embodiments.

### LIST OF REFERENCE CHARACTERS

100 vehicle
110 gateway
120 assets
130 scan range
140 warehouse or jobsite environment
S100 determining at a first time a first set of assets
S200 determining at a second time a second set of assets
S300 monitoring a motion status indicator of the vehicle
S400 forming an intersection of at least the first set of assets and the second set of assets

What is claimed is:

1. A method to determine assets (120) which are present on a vehicle (100), comprising the steps of:
determining (S100) at a first time a first set of assets (120) by an asset detector, wherein the asset detector is disposed on the vehicle (100);
determining (S200) at a second time a second set of assets (120) by the asset detector;
monitoring (S300) a motion status indicator of the vehicle (100) by a vehicle motion status monitor; and
forming (S400) an intersection of at least the first set of assets (120) and the second set of assets (120);
wherein the motion status indicator indicates a motion of the vehicle (100) at the first time;
wherein the motion status indicator indicates a motion of the vehicle (100) between the first time and the second time or a motion which is stopped for less than a predefined time period between the first time and the second time.

2. The method according to claim 1, further comprising the steps of:
determining at one or more further times one or more further sets of assets (120) by the asset detector; and
forming the intersection including the one or more further sets of assets (120), wherein the motion status indicator indicates a motion of the vehicle (100) between the second time and the one or more further times or a motion which is stopped for less than a predefined time period between the second time and the one or more further times.

3. The method according to claim 1, wherein the intersection is formed by intersecting at least a first intersection and a second intersection or a first intersection and a third set of assets (120).

4. The method according to claim 1, wherein the motion status monitor is receiving the motion status indicator from a sensor on the vehicle (100), wherein the sensor is:
a GPS sensor;
a motion sensor or a vibration sensor; and/or
an acceleration sensor.

5. The method according to claim 1, wherein the motion status monitor is receiving the motion status indicator from the vehicle (100) as:
an ignition-on-indicator;
vehicle speed or wheel speed sensor data;
GPS data;
rotational speed data; and/or
battery voltage data.

6. The method according to claim 5, wherein the motion status indicator is received via an on-board-diagnostics (OBD) of the vehicle (100), via a controlled area network (CAN) bus, via a Deutsch connector, and/or using a SAE J1939 protocol.

7. The method according to claim 1, wherein determining the assets (120) by the asset detector comprises scanning by a gateway (110) for RF signals of assets (120) or tags and wherein the RF signals are Bluetooth signals and/or are from RFID transponders.

8. The method according to claim 1, wherein the period between the first time and the second time is larger than a predefined minimum period, wherein the vehicle speed between the first time and the second time is higher than a predetermined minimum speed and/or the distance travelled by the vehicle (100) exceeds a predetermined minimum distance.

9. The method according to claim 1, further comprising the step of sending via a cellular phone network:
the determined first, second and/or one or more further sets of assets (120);
the monitored motion status indicator; and/or
the formed intersection;
to a server or a backend of an asset management system.

10. An asset determination system for a vehicle (100), comprising:
an asset detector configured to determine at a first time a first set of assets (120) and at a second time a second set of assets (120);
a vehicle status monitor configured to monitor a motion status indicator of the vehicle (100); and
one or more processors configured to:
choose the first time such that the motion status indicator indicates a motion of the vehicle (100) at the first time;
choose the second time such that the motion state indicator indicates a motion of the vehicle (100) between the first time and the second time or a motion which is stopped for less than a predefined time period between the first time and the second time; and
form an intersection of at least the first set of assets (120) and the second set of assets (120).

11. The asset determination system according to claim 10, further comprising:
a GPS sensor;
a motion sensor;
a vibration sensor; and/or
an acceleration sensor;
to provide the motion status indicator for the vehicle status monitor.

12. The asset determination system according to claim 10, further comprising a connector connectable to the vehicle (100) for receiving the motion status indicator by the vehicle status monitor.

13. The asset determination system according to claim 10, wherein a mobile phone or a smart phone and/or a device built-in into electronics of the vehicle (100) is used:
as the asset detector;
as the vehicle status monitor;
to choose the first time and/or the second time and/or to form the intersection.

14. A vehicle (100), comprising:
the asset determination system according to claim 10, wherein the asset determination system is connected to the vehicle (100).

15. A computer program product comprising instructions which, when the program is executed by a computer, cause the computer to carry out the method of claim 1 with the system according to claim 10 and/or the vehicle (100) according to claim 14.
